(19) United States
(12) Patent Application Publication
(10) Pub. No.: US 2024/0075666 A1
(43) Pub. Date: Mar. 7, 2024

(54) INJECTION MOLDING MACHINE

(71) Applicant: THE JAPAN STEEL WORKS, LTD., Tokyo (JP)

(72) Inventors: Yutaka NAKAGAWA, Tokyo (JP); Yusuke YONEHARA, Tokyo (JP); Toshio TOYOSHIMA, Tokyo (JP)

(21) Appl. No.: 18/235,843

(22) Filed: Aug. 19, 2023

(30) Foreign Application Priority Data
Sep. 5, 2022 (JP) 2022-140801

(51) Int. Cl. B29C 45/40; B29C 45/50

(52) U.S. Cl. CPC B29C 45/4005; B29C 45/5008; B29C 2045/5088

(57) ABSTRACT

An injection molding machine includes an injection apparatus configured to perform an injection operation of a material and a mold clamping apparatus configured to mold the material injected from the injection apparatus. Here, the injection apparatus includes a screw, a piston connected to the screw, and a hydraulic apparatus configured to drive the piston in an axial direction. On the other hand, the mold clamping apparatus includes a movable platen to which a first mold can be attached, a fixed platen to which a second mold can be attached, and an electric drive unit configured to move the movable platen in a mold closing direction or a mold opening direction with respect to the fixed platen.

### CROSS-REFERENCE TO RELATED APPLICATION

The present application claims priority from Japanese Patent Application No. 2022-140801 filed on Sep. 5, 2022, the contents of which are hereby incorporated by reference into this application.

### TECHNICAL FIELD OF THE INVENTION

The present invention relates to an injection molding machine, for example, a technique effectively applied to an injection molding machine configured to manufacture a molded product by injecting a metal material.

### BACKGROUND OF THE INVENTION

Japanese Unexamined Patent Application Publication No. 2000-289066 (Patent Document 1) describes a technique related to an injection molding machine provided with an electric injection apparatus and a hydraulic mold clamping apparatus.

### SUMMARY OF THE INVENTION

The injection molding machine is an apparatus configured to manufacture a molded product by melting a material by heat and pouring the molten material into a mold, and a series of injection molding process including melting of a material, pouring (injection) into a mold, cooling, and ejection can be performed in the injection molding machine. The injection molding machine includes an injection apparatus configured to perform an injection operation of a material and a mold clamping apparatus configured to mold the material injected from the injection apparatus.

In this regard, the inventors of this application have studied the combination of the drive systems of the injection apparatus and the mold clamping apparatus from a viewpoint of reducing the manufacturing cost of the injection molding machine, promoting the size reduction thereof, or improving the performance thereof. As a result, it has become clear that there is room for improvement in the combination of the drive systems of the injection apparatus and the mold clamping apparatus in the current injection molding machine from the viewpoint of reducing the manufacturing cost of the injection molding machine, promoting the size reduction thereof, or improving the performance thereof. Therefore, in the injection molding machine, ingenuity for a combination of the drive systems of the injection apparatus and the mold clamping apparatus is desired.

An injection molding machine according to an embodiment includes an injection apparatus configured to perform an injection operation of a material and a mold clamping apparatus configured to mold the material injected from the injection apparatus. Here, the injection apparatus includes a screw, a piston connected to the screw, and a hydraulic apparatus configured to drive the piston in an axial direction. On the other hand, the mold clamping apparatus includes a movable platen to which a first mold can be attached, a fixed platen to which a second mold can be attached, and an electric drive unit configured to move the movable platen in a mold closing direction or a mold opening direction with respect to the fixed platen.

According to an embodiment, it is possible to realize at least one of the reduction in manufacturing cost of the injection molding machine, the promotion of size reduction thereof, and the improvement in performance thereof.

### BRIEF DESCRIPTIONS OF THE DRAWINGS

FIG. 1 is a schematic diagram showing a configuration of an injection molding machine;

FIG. 2 is a diagram showing a schematic configuration of an injection molding machine according to a related art; and

FIG. 3 is a diagram showing a schematic configuration of an injection molding machine according to an embodiment.

### DESCRIPTIONS OF THE PREFERRED EMBODIMENTS

In all of the drawings for describing the embodiment, the same members are denoted by the same reference characters in principle and repetitive descriptions thereof will be omitted. Note that hatching is applied in some cases even in plan views for making the drawings easily understood.

<Configuration of Injection Molding Machine>

The technical idea of the present embodiment can be widely applied to an injection molding machine provided with an injection apparatus and a molding clamping apparatus. In this regard, an injection molding machine in which one injection apparatus is provided for one mold clamping apparatus will be taken as an example below to describe the technical idea of the present embodiment. However, the technical idea of the present embodiment can be widely applied not only to the injection molding machine mentioned above but also to a “multi-injection molding machine” in which a plurality of injection apparatuses are provided for one mold clamping apparatus.

<<Outline of Injection Molding Machine>>

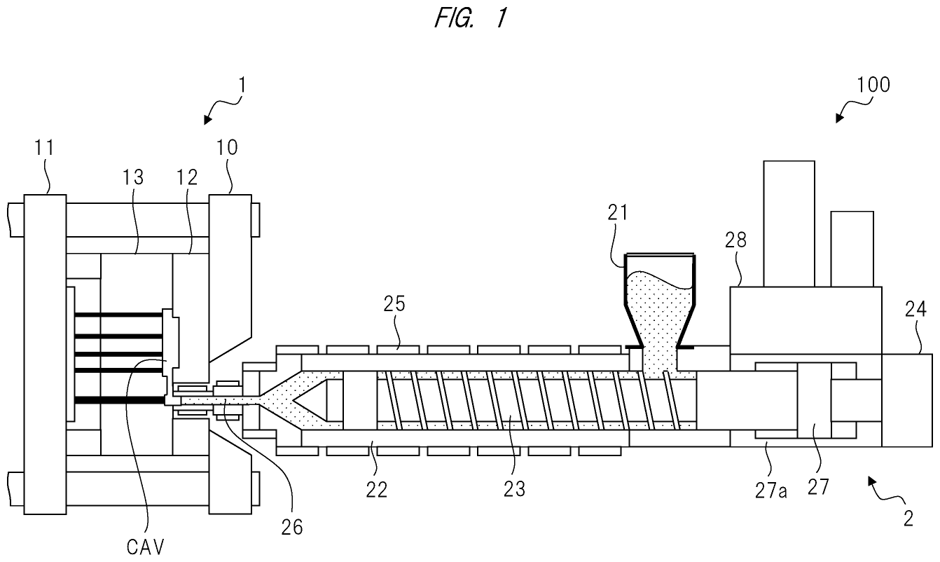

FIG. 1 is a schematic diagram showing a configuration of an injection molding machine 100.

In FIG. 1, the injection molding machine 100 includes a mold clamping apparatus 1 and an injection apparatus 2. Here, the mold clamping apparatus 1 performs a mold clamping operation. For example, the mold clamping apparatus 1 is configured such that molds into which a material injected from the injection apparatus 2 is poured can be attached, and a molded product is manufactured by pouring the material into a cavity (closed space) formed by performing the mold clamping operation to the molds in the mold clamping apparatus 1. On the other hand, the injection apparatus 2 performs an injection operation. For example, the injection apparatus 2 kneads and melts a material and injects the kneaded and molten material into the cavity formed in the mold clamping apparatus 1.

<<Configuration of Mold Clamping Apparatus>>

As shown in FIG. 1, the mold clamping apparatus 1 includes a movable platen 11 and a fixed platen 10, and is configured to be able to variably control the distance between the movable platen 11 and the fixed platen 10. Further, a movable mold (metal mold) 13 and a fixed mold (metal mold) 12 can be arranged between the movable platen 11 and the fixed platen 10. Therefore, for example, by variably controlling the distance between the movable platen 11 and the fixed platen 10 by the mold clamping apparatus 1, the distance between the movable mold 13 and the fixed mold 12 can be shortened to “close” the molds, and the distance between the movable mold 13 and the fixed mold 12 can be increased to “open” the molds. At this time, when the movable mold 13 and the fixed mold 12 are “closed”, a closed space (cavity) CAV is formed between the movable mold 13 and the fixed mold 12, and a molded product is formed by pouring a material into this closed space CAV. In particular, in the injection molding machine 100 shown in FIG. 1, one closed space CAV is formed when the movable mold 13 and the fixed mold 12 are “closed”, and a molded product is formed by pouring a material into this closed space CAV. The mold clamping apparatus 1 is configured as described above.

<<Configuration of Injection Apparatus>>

Next, as shown in FIG. 1, the injection apparatus 2 configured to extrude a material is connected to the mold clamping apparatus 1, and the material extruded from the injection apparatus 2 is poured into the closed space CAV formed by “closing” the movable mold 13 and the fixed mold 12.

This injection apparatus 2 has a hopper 21 for putting in the material (raw material) and a cylinder 22, and a nozzle 26 is provided at a distal end of the cylinder 22. When the material is put into the hopper 21, this material is kneaded by a rotatable screw 23 arranged inside the cylinder 22. At this time, a heater is arranged around the cylinder 22, and the material put into the cylinder 22 is kneaded by the rotating screw 23 while being heated by the heater 25 to become a molten material.

Here, the screw 23 is connected to a screw rotation drive mechanism 24 via a piston 27, and the screw 23 is rotated by the screw rotation drive mechanism 24. For example, a screw rotation motor can be presented as the screw rotation drive mechanism 24. Further, the piston 27 is connected to the screw 23. The piston 27 is arranged inside a cylinder 27a and a forward movement and a backward movement thereof are controlled by a hydraulic apparatus 28. Therefore, for example, when the piston 27 is controlled to move forward by the hydraulic apparatus 28, the screw 23 connected to the piston 27 moves forward, so that the molten material extruded by the screw 23 moving forward is injected from the nozzle 26. The injection apparatus 2 is configured as described above.

<Operation of Injection Molding Machine>

The injection molding machine 100 is configured as described above, and the operation thereof will be described below.

First, in FIG. 1, when the material to be injected is a metal material, a release agent is sprayed on cavity surfaces of the movable mold 13 and fixed mold 12 in an open state. Thereafter, the movable platen 11 of the mold clamping apparatus 1 is moved. In this way, the movable mold 13 is brought into contact with the fixed mold 12 to “close” the molds. Thereafter, the piston 27 is controlled to move in a forward direction by the hydraulic apparatus 28. Thus, the screw 23 connected to the piston 27 moves in a leftward direction, that is, in the forward direction. As a result, a predetermined amount of molten material accumulated between the nozzle 26 and the screw 23 by a measuring step to be described later is injected into the closed space CAV (cavity) between the movable mold 13 and the fixed mold 12 in a “closed” state from a tip of the nozzle 26. Namely, the measured molten material is injected from the nozzle 26 into the closed space CAV (injection step).

Subsequently, after the injection is finished, pressure is applied to the material in the closed space CAV via the molten material remaining in the cylinder 22 in order to compensate for the contraction of the material caused by the cooling of the molten material. Namely, after the molten material is injected, the state in which the pressure is applied to the closed space CAV by the screw 23 is maintained. This state is referred to as a “pressure keeping state”, and the molten material is cooled by the movable mold 13 and the fixed mold 12 that are controlled at a temperature equal to or lower than the temperature at which the molten material solidifies, while maintaining the pressure keeping state (pressure keeping step). Specifically, the molten material filled in the closed space CAV is cooled to a temperature equal to or lower than the temperature at which the molten material solidifies by the movable mold 13 and the fixed mold 12.

Next, in FIG. 1, a solid material is put into the cylinder 22 from the hopper 21. Then, the screw 23 is driven to rotate by the screw rotation drive mechanism 24, and at the same time, the piston 27 is moved backward by the hydraulic apparatus 28, whereby the screw 23 connected to the piston 27 is moved backward by a predetermined distance. During this time, the material supplied from the hopper 21 is melted in the cylinder 22 of the injection apparatus 2 and is moved forward by the rotation of the screw 23. In other words, the material supplied from the hopper 21 is heated and melted into a molten material by the heat generated by the heater 25 and the shear heat of the material generated by the rotation of the screw 23, and is moved forward as the molten material. As a result, a predetermined amount of molten material is accumulated between the nozzle 26 and the screw 23 (measuring step).

Thereafter, the movable mold 13 and the fixed mold 12 are “opened” by operating the mold clamping apparatus 1. After the movable mold 13 and the fixed mold 12 are “opened” in this way, an ejector apparatus provided in the mold clamping apparatus 1 ejects the molded product with an ejector pin. In this way, the molded product can be taken out from the mold clamping apparatus 1. This molded product is a product molded by the injection molding machine 100.

By repeating a series of operations described above, it is possible to continuously manufacture molded products with the same shape. By repeatedly operating the injection molding machine 100 as described above, molded products can be mass-produced.

<Study by Inventors>

The inventors of this application have been studying the injection molding machine 100 having the configuration described above. Specifically, the inventors have been studying the combination of the drive systems of the mold clamping apparatus 1 and the injection apparatus 2 from the viewpoint of reducing the manufacturing cost of the injection molding machine 100, promoting the size reduction thereof, or improving the performance thereof. As a result, it has become apparent that the combination of the drive systems of the mold clamping apparatus 1 and the injection apparatus 2 in the injection molding machine 100 needs to be considered for improvement from the viewpoint of reducing the manufacturing cost of the injection molding machine 100, promoting the size reduction thereof, or improving the performance thereof. Therefore, in the injection molding machine 100, ingenuity for a combination of the drive systems of the mold clamping apparatus 1 and the injection apparatus 2 is desired. In the following, first, drive systems of a mold clamping apparatus 1R and an injection apparatus 2R in a related art will be described. Then, the room for improvement in the drive systems in the related art will be described. Thereafter, drive systems of a mold clamping apparatus 1A and an injection apparatus 2A according to the present embodiment to which the ingenuity for the room for improvement in the related art is applied will be described.

### DESCRIPTION OF RELATED ART

The “related art” referred to in this specification is not a publicly known technique, but is a technique having a problem discovered by the inventors of this application and is a technique to be the premise of the technical idea of the present embodiment.

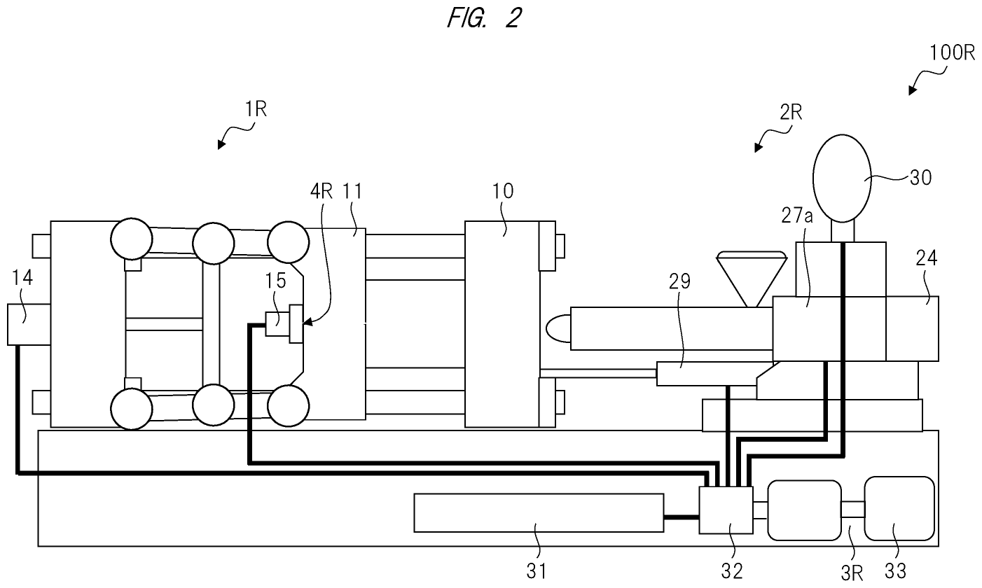

FIG. 2 is a diagram showing a schematic configuration of an injection molding machine 100R in the related art.

In FIG. 2, the injection molding machine 100R includes a mold clamping apparatus 1R, an injection apparatus 2R, and a hydraulic apparatus 3R. The mold clamping apparatus 1R is configured to mold a material injected from the injection apparatus 2R, and includes the movable platen 11 to which a movable mold (first mold) can be attached, the fixed platen 10 to which a fixed mold (second mold) can be attached, and an ejector apparatus 4R configured to eject the molded product. Further, the mold clamping apparatus 1R includes a mold opening/closing hydraulic cylinder 14, and the mold opening/closing hydraulic cylinder 14 is controlled by the hydraulic apparatus 3R. Namely, the “mold closing operation” and the “mold opening operation” in the mold clamping apparatus 1R are performed by controlling the movement of the mold opening/closing hydraulic cylinder 14 in the forward and backward directions by the hydraulic apparatus 3R. Also, the ejector apparatus 4R includes an ejector hydraulic cylinder 15, and the ejector hydraulic cylinder 15 is also controlled by the hydraulic apparatus 3R. In other words, the “ejection operation” in the ejector apparatus 4R is performed by controlling the movement of the ejector hydraulic cylinder 15 by the hydraulic apparatus 3R. The mold clamping apparatus 1R in the related art is configured as described above.

Next, the injection apparatus 2R is configured to perform the injection operation of the material, and includes the screw rotation drive mechanism 24 for rotating the screw in the rotation direction. Further, the injection apparatus 2R includes a cylinder 27a, an injection unit moving cylinder 29, and an accumulator 30 as components controlled by the hydraulic apparatus 3R. The screw is configured to be rotatable by the screw rotation drive mechanism 24, and the material supplied from the hopper is kneaded and melted to produce a molten material by rotating the screw by the screw rotation drive mechanism 24. The piston moving in the cylinder 27a is configured such that the forward and backward movement thereof is controlled by the hydraulic apparatus 3R, and the injection operation of the molten material by the screw connected to the piston is performed by controlling the movement of the piston by the hydraulic apparatus 3R. Also, injection units (for example, the components of the injection apparatus 2 shown in FIG. 1) which are the main parts of the injection apparatus 2R are configured to be able to move in the forward and backward directions by controlling the injection unit moving cylinder 29 by the hydraulic apparatus 3R. Further, the accumulator 30 is configured to be able to store oil by the hydraulic apparatus 3R, and the stored oil is released to move the piston, which moves in the cylinder 27a, forward at high speed. The injection apparatus 2R in the related art is configured as described above.

Further, the hydraulic apparatus 3R includes an oil tank 31, a hydraulic pump 32, and an electric motor 33, and is configured to control the operations of the mold clamping apparatus 1R and the injection apparatus 2R. Specifically, the hydraulic apparatus 3R is configured to control the “mold closing operation”, the “mold opening operation”, and the “ejection operation” by supplying the oil stored in the oil tank 31 to the mold opening/closing hydraulic cylinder 14 of the mold clamping apparatus 1R and the ejector hydraulic cylinder 15 of the ejector apparatus 4R by the hydraulic pump 32 actuated by the electric motor 33. Further, the hydraulic apparatus 3R is configured to control the “injection operation”, the “moving operation of the injection unit”, and the “oil storing/releasing operation for the accumulator 30” by supplying the oil stored in the oil tank 31 to the cylinder 27a, the injection unit moving cylinder 29, and the accumulator 30 of the injection apparatus 2R by the hydraulic pump 32 actuated by the electric motor 33. The hydraulic apparatus 3R in the related art is configured as described above.

<Room for Improvement>

As described above, in the injection molding machine 100R in the related art, the drive system of the mold clamping apparatus 1R and the drive system of the injection apparatus 2R are both the hydraulic control system using the hydraulic apparatus 3R. In this case, according to the study by the inventors of this application, there is room for improvement from the viewpoint of reducing the manufacturing cost of the injection molding machine 100R, promoting the size reduction thereof, or improving the performance thereof.

For example, when focusing on the mold clamping apparatus 1R, it is desirable to perform the “mold closing operation” and the “mold opening operation” in the mold clamping apparatus 1R at high speed. This is because if the time required for the “mold closing operation” and the “mold opening operation” can be shortened, the efficiency of manufacturing molded products in the injection molding machine 100R can be improved. In this regard, if the “mold closing operation” and the “mold opening operation” are to be performed at high speed by the hydraulic drive system using the hydraulic apparatus 3R, a pump, an accumulator, and others are newly required, resulting in the increase in manufacturing cost of the hydraulic apparatus 3R and the increase in size of the hydraulic apparatus 3R. Namely, when the “mold closing operation” and the “mold opening operation” in the mold clamping apparatus 1R are to be performed at high speed by using the hydraulic apparatus 3R as in the related art, there is room for improvement from the viewpoint of reducing the manufacturing cost of the injection molding machine 100R and promoting the size reduction thereof.

Furthermore, in the related art, the “mold closing operation” and the “mold opening operation” by the mold clamping apparatus 1R depend on the operation of the mold opening/closing hydraulic cylinder 14, but the stopping accuracy of the movable platen 11 is low because the operation stopping accuracy is low in the hydraulic drive. In other words, the stop position of the movable platen 11 varies in the related art. As described above, in the related art in which the “mold closing operation” and the “mold opening operation” of the mold clamping apparatus 1R are controlled by the hydraulic apparatus 3R, there is room for improvement from the viewpoint of improving the performance of the injection molding machine 100R.

In addition, since the hydraulic pump 32 is actuated by the electric motor 33 in the hydraulic apparatus 3R, the noise may be increased, and oil leakage may occur from the hydraulic equipment or the hydraulic pipe attachment portion when the hydraulic apparatus 3R is used.

Furthermore, for example, when a composite operation is to be realized in the mold clamping apparatus 1R, drive sources (such as hydraulic pumps) equal to the number of components involved in the composite operation are required, resulting in the complication and the size increase of the hydraulic apparatus 3R.

In view of the above, it can be seen that there is room for improvement in the related art in which the operation of the mold clamping apparatus 1R is controlled by the hydraulic apparatus 3R from the viewpoint of reducing the manufacturing cost of the injection molding machine 100R, promoting the size reduction thereof, or improving the performance thereof. Therefore, an ingenuity for the room for improvement in the related art is applied in the present embodiment. The technical idea of the present embodiment to which this ingenuity is applied will be described below.

<Configuration of Injection Molding Machine According to Present Embodiment>

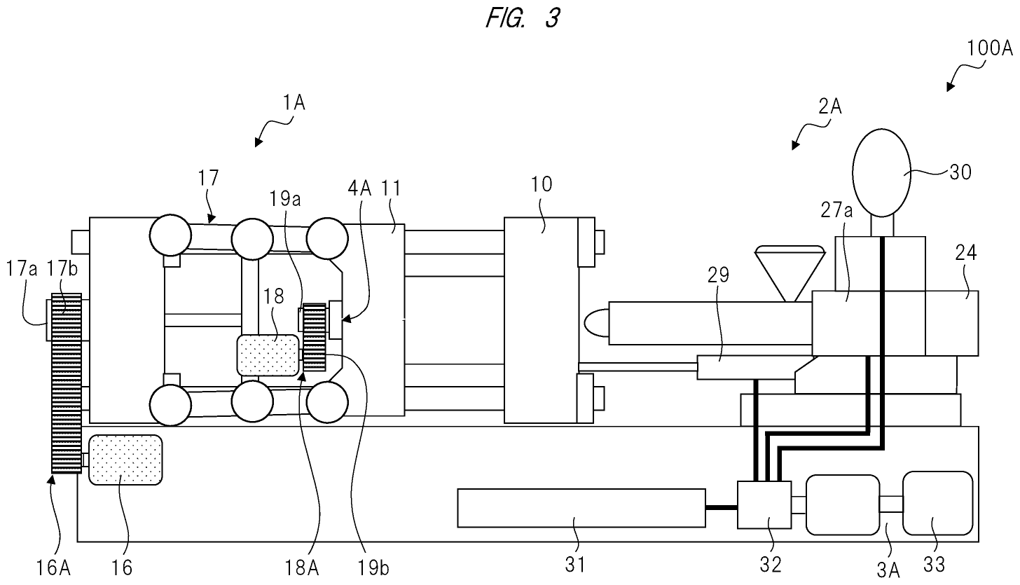

FIG. 3 is a diagram showing a schematic configuration of an injection molding machine 100A according to the present embodiment.

In FIG. 3, the injection molding machine 100A includes an injection apparatus 2A configured to perform an injection operation of a material and a mold clamping apparatus 1A configured to mold the material injected from the injection apparatus 2A.

<<Configuration of Mold Clamping Apparatus>>

The mold clamping apparatus 1A includes the movable platen 11 to which a movable mold (first mold) can be attached, the fixed platen 10 to which a fixed mold (second mold) can be attached, and an ejector apparatus 4R configured to eject the molded product. Further, the mold clamping apparatus 1A includes an electric drive unit 16A configured to move the movable platen 11 in a mold closing direction or a mold opening direction with respect to the fixed platen 10. The electric drive unit 16A includes a mold opening/closing electric motor 16 and a drive mechanism 17. The drive mechanism 17 can be composed of, for example, a toggle mechanism or a direct pressure mechanism.

The drive mechanism 17 is connected to the movable platen 11, and is configured to move the movable platen 11 in the mold closing direction or the mold opening direction by the driving force of the mold opening/closing electric motor 16. Specifically, the mold opening/closing electric motor 16 is connected to a pulley 17a via a belt 17b, and the drive mechanism 17 having the pulley 17a is operated by transmitting the rotational driving force of the mold opening/closing electric motor 16 to the pulley 17a via the belt 17b. As a result, the movable platen 11 connected to the drive mechanism 17 moves in the mold closing direction or the mold opening direction. As described above, in the present embodiment, the “mold closing operation” and the “mold opening operation” in the mold clamping apparatus 1A are performed by the electric drive unit 16A including the mold opening/closing electric motor 16.

In addition, the mold clamping apparatus 1A includes an ejector apparatus 4A configured to eject a molded product made of a molded material, and the ejector apparatus 4A includes an ejection force drive unit 18A configured to generate an ejection force for ejecting the molded product.

For example, the ejection force drive unit 18A is configured to generate an ejection force by electric drive, and includes an ejector electric motor 18, a pulley 19a, and a belt 19b as shown in FIG. 3. Specifically, the ejector electric motor 18 is connected to the pulley 19a via the belt 19b, and the rotational driving force of the ejector electric motor 18 is transmitted to the pulley 19a via the belt 19b, whereby the ejector pin is ejected via the pulley 19a. As described above, in the present embodiment, the “ejection operation” in the ejector apparatus 4A is performed by the ejection force drive unit 18A including the ejector electric motor 18.

However, the ejection force drive unit 18A provided in the ejector apparatus 4A may be configured to generate the ejection force by hydraulic drive. In this case, the ejector apparatus 4A includes, for example, an ejector hydraulic cylinder, and the “ejection operation” in the ejector apparatus 4A is performed by hydraulically driving the ejector hydraulic cylinder.

<<Operation of Mold Clamping Apparatus>>

The mold clamping apparatus 1A according to the present embodiment is configured as described above, and the operation thereof will be described below. For example, a control unit provided in the injection molding machine 100A controls the electric drive unit 16A of the mold clamping apparatus 1A. For example, the control unit provided in the injection molding machine 100A rotates the mold opening/closing electric motor 16 in the forward direction when performing the “mold closing operation” by the mold clamping apparatus 1A. In this way, the forward rotation driving force generated by the mold opening/closing electric motor 16 is transmitted to the pulley 17a via the belt 17b, so that the drive mechanism 17 having the pulley 17a is operated. As a result, the movable platen 11 connected to the drive mechanism 17 moves in the mold closing direction.

On the other hand, the control unit provided in the injection molding machine 100A rotates the mold opening/closing electric motor 16 in the reverse direction when performing the “mold opening operation” by the mold clamping apparatus 1A. In this way, the reverse rotation driving force generated by the mold opening/closing electric motor 16 is transmitted to the pulley 17a via the belt 17b, so that the drive mechanism 17 having the pulley 17a is operated. As a result, the movable platen 11 connected to the driving mechanism 17 moves in the mold opening direction.

As described above, by variably controlling the distance between the movable platen 11 and the fixed platen 10 by the mold clamping apparatus 1A, the distance between the movable mold attached to the movable platen 11 and the fixed mold attached to the fixed platen 10 can be shortened to “close” the molds, and the distance between the movable mold attached to the movable platen 11 and the fixed mold attached to the fixed platen 10 can be increased to “open” the molds. At this time, when the movable mold and the fixed mold are “closed”, a closed space (cavity) is formed between the movable mold and the fixed mold, and a molded product is manufactured by pouring a material into this closed space.

Then, when the molds are “opened” after the molded product is manufactured, the control unit provided in the injection molding machine 100A controls the ejection force drive unit 18A of the ejector apparatus 4A. Specifically, the control unit provided in the injection molding machine 100A performs the “ejection operation” by the ejector apparatus 4A. In this case, the control unit rotates the ejector electric motor 18 in the forward direction. In this way, the forward rotation driving force generated by the ejector electric motor 18 is transmitted to the pulley 19a via the belt 19b, so that the ejector pin connected to the pulley 19a is ejected. As a result, the molded product is ejected by the ejector pin to be taken out from the cavity. Thereafter, when the molded product is taken out, the control unit rotates the ejector electric motor 18 in the reverse direction. In this way, the reverse rotation driving force generated by the ejector electric motor 18 is transmitted to the pulley 19a via the belt 19b, so that the ejector pin connected to the pulley 19a is housed in the movable platen 11.

As described above, the “mold closing operation” and the “mold opening operation” in the mold clamping apparatus 1A are performed by the electric drive unit 16A including the mold opening/closing electric motor 16, and the “ejector pin ejection operation” and the “ejector pin housing operation” in the ejector apparatus 4A can be performed by the ejection force drive unit 18A including the ejector electric motor 18.

<<Configuration of Injection Apparatus>>

The injection apparatus 2A is configured to perform the injection operation of the material, and includes the screw rotation drive mechanism 24 for rotating the screw in the rotation direction. Further, the injection apparatus 2A includes the cylinder 27a, the injection unit moving cylinder 29, and the accumulator 30 as components controlled by a hydraulic apparatus 3A. The screw is configured to be rotatable by the screw rotation drive mechanism 24, and the material supplied from the hopper is kneaded and melted to produce a molten material by rotating the screw by the screw rotation drive mechanism 24. The piston moving in the cylinder 27a is configured such that the forward and backward movement thereof is controlled by the hydraulic apparatus 3A, and the injection operation of the molten material by the screw connected to the piston is performed by controlling the movement of the piston by the hydraulic apparatus 3A. Also, injection units (for example, the components of the injection apparatus 2 shown in FIG. 1) which are the main parts of the injection apparatus 2A are configured to be able to move in the forward and backward directions by controlling the injection unit moving cylinder 29 by the hydraulic apparatus 3A. Further, the accumulator 30 is configured to be able to store oil by the hydraulic apparatus 3A, and the stored oil is released to move the piston, which moves in the cylinder 27a, forward at high speed.

The injection apparatus 2A includes the hydraulic apparatus 3A. The hydraulic apparatus 3A includes the oil tank 31, the hydraulic pump 32, and the electric motor 33, and is configured to control the operation of the injection apparatus 2A. Specifically, the hydraulic apparatus 3A is configured to control the “injection operation”, the “moving operation of the injection unit”, and the “oil storing/releasing operation for the accumulator 30” by supplying the oil stored in the oil tank 31 to the cylinder 27a, the injection unit moving cylinder 29, and the accumulator 30 of the injection apparatus 2A by the hydraulic pump 32 actuated by the electric motor 33.

<<Operation of Injection Apparatus>>

The injection apparatus 2A according to the present embodiment is configured as described above, and the operation thereof will be described below. For example, the control unit provided in the injection molding machine 100A controls the hydraulic apparatus 3A of the injection apparatus 2A. For example, the control unit provided in the injection molding machine 100A performs the “oil storing operation for the accumulator 30” by supplying the oil stored in the oil tank 31 to the accumulator 30 of the injection apparatus 2A by the hydraulic pump 32 actuated by the electric motor 33. Also, the control unit provided in the injection molding machine 100A performs the “moving operation of the injection unit” by supplying the oil stored in the oil tank 31 to the injection unit moving cylinder 29 of the injection apparatus 2A by the hydraulic pump 32 actuated by the electric motor 33. Further, the control unit provided in the injection molding machine 100A performs the “injection operation” by supplying the oil stored in the oil tank 31 to the piston moving in the cylinder 27a of the injection apparatus 2A by the hydraulic pump 32 actuated by the electric motor 33 and by supplying (releasing) the oil stored in the accumulator 30 to the piston moving in the cylinder 27a of the injection apparatus 2A.

As described above, the “injection operation”, the “moving operation of the injection unit”, and the “storing/releasing operation of the oil for the accumulator 30” in the injection apparatus 2A can be performed by the hydraulic apparatus 3A included in the injection apparatus 2A.

<Feature of Present Embodiment>

Subsequently, the feature of the present embodiment will be described.

The feature of the present embodiment lies in that the electric drive system using the mold opening/closing electric motor 16 is adopted as the drive system for the “mold closing operation” and the “mold opening operation” in the mold clamping apparatus 1A and the hydraulic drive system using the hydraulic apparatus 3A is adopted as the drive system for the “injection operation” and the “oil storing/releasing operation for the accumulator 30” in the injection apparatus 2A as shown in FIG. 3. In this way, according to the feature of the present embodiment, it is possible to reduce the manufacturing cost of the injection molding machine 100, promote the size reduction thereof, or improve the performance thereof.

First, the technical significance of adopting the electric drive system using the mold opening/closing electric motor 16 as the drive system for the “mold closing operation” and the “mold opening operation” in the mold clamping apparatus 1A will be described.

For example, it is desirable to perform the “mold closing operation” and the “mold opening operation” in the mold clamping apparatus 1A at high speed. This is because if the time required for the “mold closing operation” and the “mold opening operation” can be shortened, the efficiency of manufacturing molded products in the injection molding machine 100A can be improved.

In this regard, it is conceivable to perform the “mold closing operation” and the “mold opening operation” in the mold clamping apparatus 1A by the hydraulic drive system using the hydraulic apparatus 3A. However, if the “mold closing operation” and the “mold opening operation” are to be performed at high speed by the hydraulic drive system using the hydraulic apparatus 3A, a pump, an accumulator, and others are newly required, resulting in the increase in manufacturing cost of the hydraulic apparatus 3A and the increase in size of the hydraulic apparatus 3A. Namely, if the “mold closing operation” and the “mold opening operation” are to be performed at high speed by the hydraulic drive system, it is necessary to increase the size of the hydraulic apparatus 3A.

On the other hand, when the electric drive system using the mold opening/closing electric motor 16 is adopted as the drive system for the “mold closing operation” and the “mold opening operation” in the mold clamping apparatus 1A as in the present embodiment, large-sized components as those in the hydraulic drive system using the hydraulic apparatus are not required even when the “mold closing operation” and the “mold opening operation” are performed at high speed. For this reason, by adopting the electric drive system using the mold opening/closing electric motor 16 as the drive system for the “mold closing operation” and the “mold opening operation” in the mold clamping apparatus 1A, it is possible to reduce the manufacturing cost of the injection molding machine 100A and promote the size reduction thereof. Namely, it can be said that the technical significance of adopting the electric drive system using the mold opening/closing electric motor 16 as the drive system for the “mold closing operation” and the “mold opening operation” in the mold clamping apparatus 1A lies in that large-sized components become unnecessary, so that it is possible to reduce the manufacturing cost of the injection molding machine 100A and promote the size reduction thereof.

Furthermore, in the hydraulic drive system, the “mold closing operation” and the “mold opening operation” by the mold clamping apparatus depend on the operation of the mold opening/closing hydraulic cylinder, but the stopping accuracy of the movable platen 11 is low because the operation stopping accuracy is low in the hydraulic drive. In other words, the stop position of the movable platen 11 varies in the hydraulic drive system. On the other hand, in the electric drive system, the moving operation or the stopping operation of the movable platen 11 is electrically controlled. Therefore, in the electric drive system, the moving operation or the stopping operation of the movable platen 11 is performed as instructed by electrical control, so that the stopping accuracy of the movable platen 11 can be improved. In other words, the variation in the stop position of the movable platen 11 can be reduced in the electric drive system. Therefore, if the electric drive system using the mold opening/closing electric motor 16 is adopted as the drive system for the “mold closing operation” and the “mold opening operation” in the mold clamping apparatus 1A, an advantage of improving the performance of the injection molding machine 100A can be obtained in addition to the reduction in manufacturing cost of the injection molding machine 100A and the promotion of size reduction thereof.

In addition, when a composite operation is to be realized by the hydraulic drive system, drive sources (such as hydraulic pumps) equal to the number of components involved in the composite operation are required, resulting in the complication and the size increase of the hydraulic apparatus 3A. On the other hand, when the composite operation is to be realized by the electric drive system, the hardware (drive source: mold opening/closing electric motor 16) can be operated as it is if the software is adapted. Therefore, an advantage of easily realizing the composite operation can also be obtained in the electric drive system without leading to the complication and the size increase of the system.

Subsequently, the technical significance of adopting the hydraulic drive system using the hydraulic apparatus 3A as the drive system for the “injection operation” and the “oil storing/releasing operation for the accumulator 30” in the injection apparatus 2A will be described. For example, a metal material is assumed as a material (molten material) injected from the injection apparatus 2A in the present embodiment. Examples of the metal material include a magnesium alloy material. Here, since the molten material made of a metal material is easily solidified, it is necessary to increase the injection speed of the material from the injection apparatus 2A.

In this regard, it is conceivable to adopt the electric drive system as the drive system for the “injection operation” in the injection apparatus 2A. However, in the electric drive system, it is difficult to configure the injection apparatus 2A so as to be able to increase the injection speed of the material. Namely, in the injection apparatus 2A which injects an easily solidified metal material such as magnesium alloy, the hydraulic drive system that releases the hydraulic oil accumulated in the accumulator 30 or the like at once is required in order to obtain the high injection speed.

Therefore, in the present embodiment, the hydraulic drive system using the hydraulic apparatus 3A is adopted as the drive system for the “injection operation” and the “oil storing/releasing operation for the accumulator 30” in the injection apparatus 2A. Namely, in the present embodiment, the technical significance of adopting the hydraulic drive system using the hydraulic apparatus 3A as the drive system for the “injection operation” and the “oil storing/releasing operation for the accumulator 30” in the injection apparatus 2A is to obtain the high injection speed.

As described above, in the present embodiment, the hydraulic drive system using the hydraulic apparatus 3A is adopted as the drive system for the “injection operation” and the “oil storing/releasing operation for the accumulator 30” in the injection apparatus 2A. Therefore, the injection apparatus 2A includes the hydraulic apparatus 3A. Here, for the high-speed injection of the material, the hydraulic apparatus 3A needs to include the hydraulic pump 32 with the ability of being able to charge the hydraulic oil into the accumulator 30 within a molding cycle and realize the forward and backward movement of the injection unit.

Therefore, it is not necessary to increase the size of the hydraulic apparatus 3A. For example, if the hydraulic drive system is adopted not only as the drive system for the “injection operation” and the “oil storing/releasing operation for the accumulator 30” in the injection apparatus 2A but also as the drive system for the “mold closing operation” and the “mold opening operation” in the mold clamping apparatus 1A, a pump, an accumulator, and others are newly required for realizing the “mold closing operation” and the “mold opening operation” in the mold clamping apparatus 1A, resulting in the increase in manufacturing cost of the hydraulic apparatus 3A and the increase in size of the hydraulic apparatus 3A. Namely, if the hydraulic drive system is adopted not only as the drive system for the “injection operation” and the “oil storing/releasing operation for the accumulator 30” in the injection apparatus 2A but also as the drive system for the “mold closing operation” and the “mold opening operation” in the mold clamping apparatus 1A, a large-scale hydraulic drive apparatus beyond the level of the hydraulic apparatus 3A is required. In this regard, since the electric drive system is adopted as the drive system for the “mold closing operation” and the “mold opening operation” in the mold clamping apparatus 1A in the present embodiment, the large-scale hydraulic drive apparatus is unnecessary. Therefore, according to the feature of the present invention in which the electric drive system using the mold opening/closing electric motor 16 is adopted as the drive system for the “mold closing operation” and the “mold opening operation” in the mold clamping apparatus 1A and the hydraulic drive system using the hydraulic apparatus 3A is adopted as the drive system for the “injection operation” and the “oil storing/releasing operation for the accumulator 30” in the injection apparatus 2A, it is possible to reduce the manufacturing cost of the injection molding machine 100A, promote the size reduction thereof, or improve the performance thereof. For this reason, it can be said that the feature of the present embodiment is an exceptionally good technical idea in that it is possible to reduce the manufacturing cost of the injection molding machine 100A, promote the size reduction thereof, or improve the performance thereof.

Note that the injection apparatus 2A includes the screw rotation drive mechanism 24, and the drive system of the screw rotation drive mechanism 24 may be either the electric drive system or the hydraulic drive system.

However, it is desirable that the drive system of the screw rotation drive mechanism 24 is the electric drive system. This is because (1) the size of the electric motor 33 can be reduced when the hydraulic drive system is not adopted, (2) it is not necessary to provide the hydraulic pump for rotating the screw, and (3) the amount of hydraulic oil can be reduced and thus the size of the oil tank can be reduced.

Next, the drive system of the ejector apparatus 4A may be either the electric drive system or the hydraulic drive system, but the electric drive system is preferable. This is because since the drive system for the “mold closing operation” and the “mold opening operation” in the mold clamping apparatus 1A is the electric drive system, it is possible to cope with the composite operation of the mold clamping apparatus 1A and the ejector apparatus 4A by changing the software, and the composite operation can be realized without leading to the complication and the size increase of the system if the electric drive system is adopted in both of the mold clamping apparatus 1A and the ejector apparatus 4A.

Furthermore, for example, when the hydraulic drive system is adopted as the drive system of the ejector apparatus 4A, a hydraulic cylinder, a valve, a manifold, and a hydraulic pipe are required. On the other hand, when the electric drive system is adopted as the drive system of the ejector apparatus 4A, components such as a ball screw, a motor, a pulley, and a belt are required. In this regard, the electric drive system has a great advantage in that the structure and parts of the injection molding machine for manufacturing resin molded products can be used in common.

Also, as a disadvantage of the hydraulic drive system, for example, it is necessary to lay the hydraulic pipes from the drive source located on the side of the injection apparatus to the side of the mold clamping apparatus.

In recent years, there has been an increasing demand for the so-called “modularization of injection apparatus” in which injection apparatuses of different sizes are combined with one mold clamping apparatus. In this case, for example, if the hydraulic drive system is adopted as the drive system of the ejector apparatus 4A, components that straddle the injection apparatus and the mold clamping apparatus are present, and it is necessary to consider the design for each combination of the injection apparatus and the mold clamping apparatus. Therefore, if the hydraulic drive system is adopted as the drive system of the ejector apparatus 4A, the hydraulic pipe is present as the component that straddles the injection apparatus and the mold clamping apparatus, with the result that the design load of the injection molding machine to which the “modularization of injection apparatus” is applied increases, and the specifications also increase. On the other hand, if the electric drive system is adopted as the drive system of the ejector apparatus 4A, there is no component that straddles the injection apparatus and the mold clamping apparatus, and it is thus possible to obtain the advantage that the injection molding machine to which the “modularization of injection apparatus” is applied can be easily realized.

However, according to the study by the inventors of this application, when the electric drive system is adopted as the drive system of the ejector apparatus 4A, the ejection force by the ejector pin in the “ejection operation” becomes insufficient in some cases. Therefore, from the viewpoint of ensuring a sufficient ejection force, there is also the option of adopting the hydraulic drive system as the drive system of the ejector apparatus 4A. In this case, it should be noted that hydraulic equipment and components such as a hydraulic manifold and a hydraulic pipe are required also for the mold clamping apparatus 1A.

In the foregoing, the invention made by the inventors of this application has been concretely described based on the embodiment. However, it is needless to say that the present invention is not limited to the above-described embodiment and various modifications can be made within the range not departing from the gist thereof.

What is claimed is:

1. An injection molding machine comprising:
an injection apparatus configured to perform an injection operation of a material; and
a mold clamping apparatus configured to mold the material injected from the injection apparatus,
wherein the injection apparatus includes:
a screw;
a piston connected to the screw; and
a hydraulic apparatus configured to drive the piston in an axial direction, and
wherein the mold clamping apparatus includes:
a movable platen to which a first mold can be attached;
a fixed platen to which a second mold can be attached; and
an electric drive unit configured to move the movable platen in a mold closing direction or a mold opening direction with respect to the fixed platen.

2. The injection molding machine according to claim 1,
wherein the mold clamping apparatus further includes an ejector apparatus configured to eject a molded product made of the molded material, and
wherein the ejector apparatus includes an ejection force drive unit configured to generate an ejection force for ejecting the molded product.

3. The injection molding machine according to claim 2,
wherein the ejection force drive unit generates the ejection force by electric drive.

4. The injection molding machine according to claim 1,
wherein the material is a metal material.

5. The injection molding machine according to claim 1,
wherein the material is magnesium alloy.
